(19) United States
(12) Patent Application Publication
(10) Pub. No.: US 2016/0232846 A1
(43) Pub. Date: Aug. 11, 2016

(54) PANEL DRIVING CIRCUIT AND PANEL DRIVING METHOD

(71) Applicant: SHENZHEN CHINA STAR OPTOELECTRONICS TECHNOLOGY CO. LTD., Shenzhen, Guangdong (CN)

(72) Inventor: Xiangyang XU, Shenzhen, Guangdong (CN)

(73) Assignee: Shenzhen China Star Optoelectronics Technology Co. Ltd., Shenzhen, Guangdong (CN)

(21) Appl. No.: 14/378,637

(22) PCT Filed: May 28, 2014
(86) PCT No.: PCT/CN2014/078678

§ 371 Date: Aug. 13, 2014

(30) Foreign Application Priority Data
May 15, 2014 (CN) 201410206832.9

(51) Int. Cl. G09G 3/3258; G09G 3/3291; G09G 3/3266

(52) U.S. Cl. CPC G09G 3/3258; G09G 3/3266; G09G 3/3291; G09G 2300/0842; G09G 2320/0646; G09G 2300/0809; G09G 2360/144

(57) ABSTRACT

The present invention provides a panel driving circuit and a panel driving method. The panel driving circuit comprises: a scan control transistor (T1), a driving transistor (T2), a phototransistor (T3), a storage capacitor (C1), and an Organic Light-Emitting Diode (OLED); and further comprising a scan control end (Scan n), a data signal end (Data n), a source voltage input end (Vdd) and a low voltage input end (Vgl); a driving current of the driving transistor (T2) is a grey scale current (I1), and a current of the phototransistor (T3) is an ambient light current (I2), and the grey scale current (I1) depends on the grey scale voltage stored in the storage capacitor (C1), and the ambient light current (I2) depends on ambient light dosage; a brightness of the panel depends on a sum of the grey scale current (I1) and the ambient light current (I2).

### FIELD OF THE INVENTION

The present invention relates to the field of display technology, and more particularly to a panel driving circuit and a panel driving method.

### BACKGROUND OF THE INVENTION

As being a next generation display technology, AMOLED (Active Matrix/Organic Light Emitting Diode) possesses advantages of high brightness, wide color gamut, wide view angle and great compact. Generally, LTPS skill is employed for manufacturing the AMOLED driving circuit. The luminous elements of the AMOLED are OLEDs (Organic Light-Emitting Diodes). Under the driving of the AMOLED driving circuit, the OLEDs give out light when currents flow through the OLEDs.

For now, a traditional 2T1C circuit is commonly applied for the AMOLED driving circuit. Please refer to FIG. 1, which is a diagram of a traditional AMOLED panel driving 2T1C circuit according to prior art. The circuit comprises a scan control transistor (T1′), a driving transistor (T2′), a storage capacitor (C1′) and an Organic Light-Emitting Diode (OLED′); and also comprising a scan control end (Scan n′), a data signal end (Data n′) and a source voltage input end (Vdd′); the scan control transistor (T1′) comprises a first gate (g1′), a first source (s1′) and a first drain (d1′); the driving transistor (T2′) comprises a second gate (g2′), a second source (s2′) and a second drain (d2′); the first gate (g1′) is electrically connected to the scan control end (Scan n′), and the first source (s1′) is electrically connected to the data signal end (Data n′), and the first drain (d1′) is electrically connected to the second gate (g2′) and an upper electrode of the storage capacitor (C1′); and the first drain (d1′) is electrically connected to the second gate (g2′) and the upper electrode of the storage capacitor (C1′); the anode of the Organic Light-Emitting Diode (OLED′) is electrically connected to the source voltage input end (Vdd′), and the cathode of the Organic Light-Emitting Diode (OLED′) is electrically connected to the second source (s2′); the second drain (d2′) is grounded (GND′). The driving transistor (T2′) is employed for ensuring the driving current of the AMOLED panel driving circuit, and the Organic Light-Emitting Diode (OLED′) is employed for responding the driving current and giving out light for display; the storage capacitor (C1′) mainly stores a grey scale voltage signal outputted from the data signal end (Data n′), and a driving current of the driving transistor (T2′) is decided according to the value of the grey scale voltage stored in the storage capacitor (C1′); the scan control transistor (T1′) and the driving transistor (T2′) are both thin film transistors (TFT).

However, the threshold voltage of the driving transistor (T2′) will drift as the working time goes by and leads to the unstable lighting of the Organic Light-Emitting Diode (OLED′); and due to the existence of the leakage current on the scan control transistor (T1′), the voltage of the storage capacitor (C1′) becomes unstable and then leads to that the lighting of the Organic Light-Emitting Diode (OLED′) is not steady, either. Moreover, because the threshold voltages of the driving transistors (T2′) of the respective pixels drift differently, more or less and then non-uniformly lighting appears among the respective pixels. Therefore, the traditional two transistor-one capacitor 2T1C pixel driving circuit is no longer satisfying the display demand of high quality AMOLED.

Two differences of the AMOLD from the TFT-LCD (Thin Film Transistor LCD, AM TFT-LCD) are: 1. TFT-LCD is passive emitting, and the image is shown by adjusting the back light brightness but the AMOLED is active emitting; 2. The TFT-LCD is voltage driven but the AMOLED is current driven. Therefore, AMOLED requires higher stability for the TFTs.

So far, the LTPS skill is not mature. The uniformity of the threshold voltages Vth of the TFTs manufactured by LTPS is very bad. The drifts exist and cause that nonuniform driving currents flow through the OLEDs. Consequently, the uniformity of the AMOLED brightness is descended. Because the AMOLED is current driven, and the brightness of the OLEDs are decided by the values of the currents. The bigger the currents are, the higher the brightness becomes. Nevertheless, the lifetime can be enormously shortened under a working mode of constant high brightness. Besides, the yield of the AMOLED back plate still remains very low. The lifetime and color stability of the OLED emitting material is not perfect. For that reason, the production of the AMOLED is still not good enough.

### SUMMARY OF THE INVENTION

An objective of the present invention is to provide a panel driving circuit and a panel driving method to reduce the power consumption of driving an AMOLED, and to extend the usage lifetime of the AMOLED, and to enhance display image quality.

For realizing the aforesaid objective, the present invention provides a panel driving circuit, comprising: a scan control transistor (T1), a driving transistor (T2), a phototransistor (T3), a storage capacitor (C1), and an Organic Light-Emitting Diode (OLED); and further comprising a scan control end (Scan n), a data signal end (Data n), a source voltage input end (Vdd) and a low voltage input end (Vgl); the scan control transistor (T1) comprises a first gate (g1), a first source (s1) and a first drain (d1); the driving transistor (T2) comprises a second gate (g2), a second source (s2) and a second drain (d2); the phototransistor (T3) comprises a third gate (g3) and a third source (s3) and a third drain (d3); the first gate (g1) is electrically connected to the scan control end (Scan n), and the first source (s1) is electrically connected to the data signal end (Data n), and the first drain (d1) is electrically connected to the second gate (g2) and an upper electrode of the storage capacitor (C1); a lower electrode of the storage capacitor (C1) is grounded (GND); an anode of the Organic Light-Emitting Diode (OLED) is electrically connected to the source voltage input end (Vdd), and a cathode of the Organic Light-Emitting Diode (OLED) is electrically connected to the second source (s2) and the third source (s3); the second drain (d2) and the third drain (d3) are electrically connected and then grounded (GND), and the third gate (g3) is electrically connected to the low voltage input end (Vgl).

The storage capacitor (C1) stores a grey scale voltage signal outputted from the data signal end (Data n).

A driving current of the driving transistor (T2) is a grey scale current (I1), and a current of the phototransistor (T3) is an ambient light current (I2), and the grey scale current (I1) depends on the grey scale voltage stored in the storage capacitor (C1), and the ambient light current (I2) depends on ambient light dosage; a brightness of the panel depends on a sum of the grey scale current (I1) and the ambient light current (I2).

A brightness of the panel depends on a sum of the grey scale current (I1) and the ambient light current (I2).

The scan control transistor (T1), the driving transistor (T2) and the phototransistor (T3) are all thin film transistors.

The present invention also provides a panel driving circuit, comprising: a scan control transistor (T1), a driving transistor (T2), a phototransistor (T3), a storage capacitor (C1), and an Organic Light-Emitting Diode (OLED); and further comprising a scan control end (Scan n), a data signal end (Data n), a source voltage input end (Vdd) and a low voltage input end (Vgl); the scan control transistor (T1) comprises a first gate (g1), a first source (s1) and a first drain (d1); the driving transistor (T2) comprises a second gate (g2), a second source (s2) and a second drain (d2); the phototransistor (T3) comprises a third gate (g3) and a third source (s3) and a third drain (d3); the first gate (g1) is electrically connected to the scan control end (Scan n), and the first source (s1) is electrically connected to the data signal end (Data n), and the first drain (d1) is electrically connected to the second gate (g2) and an upper electrode of the storage capacitor (C1); a lower electrode of the storage capacitor (C1) is grounded (GND); an anode of the Organic Light-Emitting Diode is electrically connected to the source voltage input end (Vdd), and a cathode of the Organic Light-Emitting Diode (OLED) is electrically connected to the second source (s2) and the third source (s3); the second drain (d2) and the third drain (d3) are electrically connected and then grounded (GND), and the third gate (g3) is electrically connected to the low voltage input end (Vgl);

wherein the storage capacitor (C1) stores a grey scale voltage signal outputted from the data signal end (Data n);

wherein a driving current of the driving transistor (T2) is a grey scale current (I1), and a current of the phototransistor (T3) is an ambient light current (I2), and the grey scale current (I1) depends on the grey scale voltage stored in the storage capacitor (C1), and the ambient light current (I2) depends on ambient light dosage; a brightness of the panel depends on a sum of the grey scale current (I1) and the ambient light current (I2);

wherein a brightness of the panel depends on a sum of the grey scale current (I1) and the ambient light current (I2);

wherein the scan control transistor (T1), the driving transistor (T2) and the phototransistor (T3) are all thin film transistors.

The present invention also provides a panel driving method, comprising:

providing a scan control transistor (T1), a driving transistor (T2), a phototransistor (T3), a storage capacitor (C1), and an Organic Light-Emitting Diode (OLED), a scan control end (Scan n), a data signal end (Data n), a source voltage input end (Vdd) and a low voltage input end (Vgl);

the scan control transistor (T1) comprises a first gate (g1), a first source (s1) and a first drain (d1); the driving transistor (T2) comprises a second gate (g2), a second source (s2) and a second drain (d2); the phototransistor (T3) comprises a third gate (g3) and a third source (s3) and a third drain (d3);

electrically connecting the first gate (g1) to the scan control end (Scan n), and electrically connecting the first source (s1) to the data signal end (Data n), and electrically connecting the first drain (d1) to the second gate (g2) and an upper electrode of the storage capacitor (C1); grounding (GND) a lower electrode of the storage capacitor (C1); electrically connecting an anode of the Organic Light-Emitting Diode (OLED) to the source voltage input end (Vdd), and electrically connecting a cathode of the Organic Light-Emitting Diode (OLED) to the second source (s2) and the third source (s3); electrically connecting the second drain (d2) and the third drain (d3) and then grounding (GND), and electrically connecting the third gate (g3) to the low voltage input end (Vgl).

The storage capacitor (C1) stores a grey scale voltage signal outputted from the data signal end (Data n).

A driving current of the driving transistor (T2) is a grey scale current (I1), and a current of the phototransistor (T3) is an ambient light current (I2), and the grey scale current (I1) depends on the grey scale voltage stored in the storage capacitor (C1), and the ambient light current (I2) depends on ambient light dosage; a brightness of the panel depends on a sum of the grey scale current (I1) and the ambient light current (I2).

A brightness of the panel depends on a sum of the grey scale current (I1) and the ambient light current (I2).

The scan control transistor (T1), the driving transistor (T2) and the phototransistor (T3) are all thin film transistors.

The benefit of the present invention is: the present invention provides a panel driving circuit and a panel driving method. By parallel connecting one phototransistor with two ends of the source and the drain of the driving transistor. The current of the phototransistor (T3) is controlled by the ambient light, and accordingly, the brightness of the panel depends on a sum of the grey scale current (I1) and the ambient light current (I2). Therefore, the brightness of the panel changes with the brightness variation of the ambient light. Consequently, the power consumption of driving the panel is reduced. The usage lifetime of the AMOLED is extended and the display image quality is enhanced.

In order to better understand the characteristics and technical aspect of the invention, please refer to the following detailed description of the present invention is concerned with the diagrams, however, provide reference to the accompanying drawings and description only and is not intended to be limiting of the invention.

### BRIEF DESCRIPTION OF THE DRAWINGS

The technical solution, as well as beneficial advantages, of the present invention will be apparent from the following detailed description of an embodiment of the present invention, with reference to the attached drawings.

In the attached drawings,

FIG. 1 is a diagram of an AMOLED panel driving 2T1C circuit according to prior art;

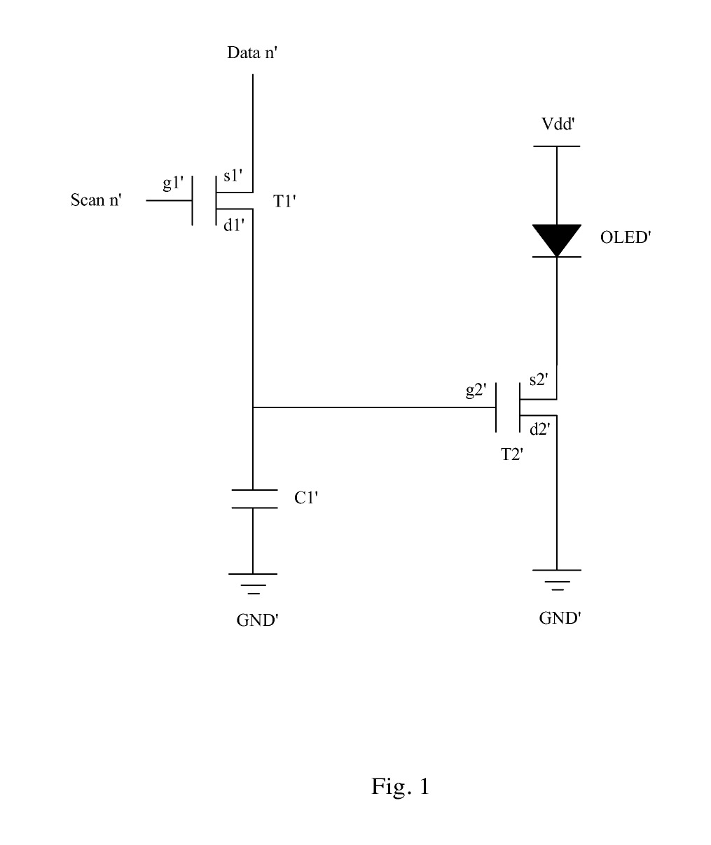

FIG. 2 is a diagram of a panel driving circuit according to the present invention;

FIG. 3 is a flowchart of a panel driving method according to the present invention.

### DETAILED DESCRIPTION OF PREFERRED EMBODIMENTS

Embodiments of the present invention are described in detail with the technical matters, structural features, achieved objects, and effects with reference to the accompanying drawings as follows.

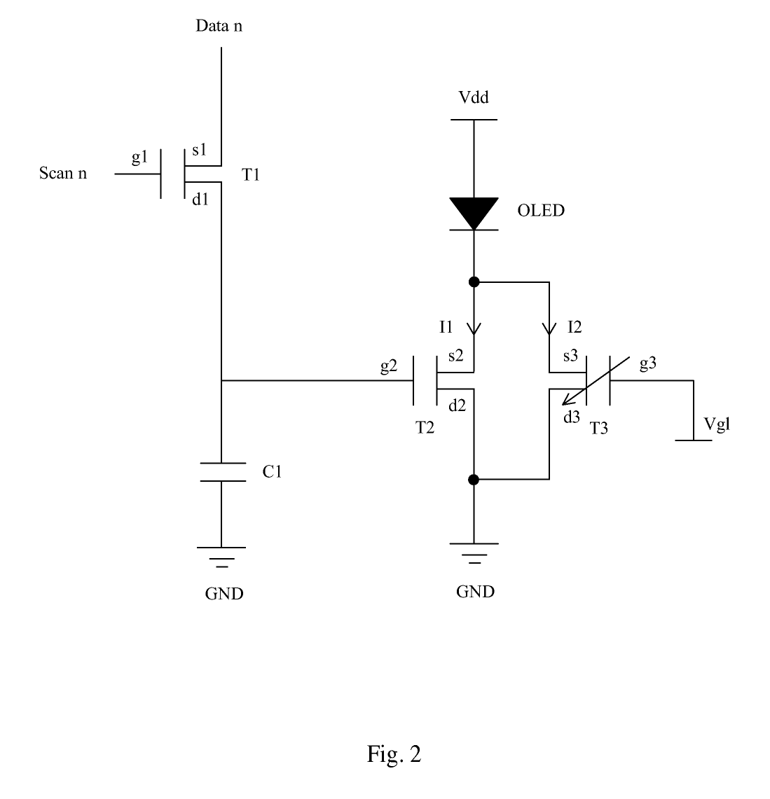

Please refer to FIG. 2, which shows a diagram of a panel driving circuit according to the present invention. The panel driving circuit comprises: a scan control transistor (T1), a driving transistor (T2), a phototransistor (T3), a storage capacitor (C1), and an Organic Light-Emitting Diode (OLED); and further comprising a scan control end (Scan n), a data signal end (Data n), a source voltage input end (Vdd) and a low voltage input end (Vgl); the scan control transistor (T1) comprises a first gate (g1), a first source (s1) and a first drain (d1); the driving transistor (T2) comprises a second gate (g2), a second source (s2) and a second drain (d2); the phototransistor (T3) comprises a third gate (g3) and a third source (s3) and a third drain (d3); the first gate (g1) is electrically connected to the scan control end (Scan n), and the first source (s1) is electrically connected to the data signal end (Data n), and the first drain (d1) is electrically connected to the second gate (g2) and an upper electrode of the storage capacitor (C1); a lower electrode of the storage capacitor (C1) is grounded (GND); an anode of the Organic Light-Emitting Diode (OLED) is electrically connected to the source voltage input end (Vdd), and a cathode of the Organic Light-Emitting Diode (OLED) is electrically connected to the second source (s2) and the third source (s3); the second drain (d2) and the third drain (d3) are electrically connected and then grounded (GND), and the third gate (g3) is electrically connected to the low voltage input end (Vgl).

The storage capacitor (C1) stores a grey scale voltage signal outputted from the data signal end (Data n), and a driving current of the driving transistor (T2) is decided according to the value of the grey scale voltage stored in the storage capacitor (C1); the scan control transistor (T1), the driving transistor (T2) and the phototransistor (T3) are all thin film transistors.

The current of the phototransistor (T3) is controlled by the ambient light. The current of the phototransistor (T3) will increase when the ambient light dosage is increased; the current of the phototransistor (T3) will decrease when the ambient light dosage is decreased.

Specifically, a driving current of the driving transistor (T2) is a grey scale current (I1), and a current of the phototransistor (T3) is an ambient light current (I2), and the grey scale current (I1) depends on the grey scale voltage stored in the storage capacitor (C1), and the ambient light current (I2) depends on ambient light dosage. When the ambient light becomes stronger, the ambient light current (I2) becomes larger. A brightness of the panel depends on a sum of the grey scale current (I1) and the ambient light current (I2). That is, the ambient light current (I2) will increase when the ambient light dosage is increased. The brightness of the Organic Light-Emitting Diode (OLED) will be raised, accordingly; the ambient light current (I2) will decrease when the ambient light dosage is decreased. The brightness of the Organic Light-Emitting Diode (OLED) becomes lower, accordingly.

The panel of the present embodiment is an Active Matrix/Organic Light Emitting Diode (AMOLED) panel.

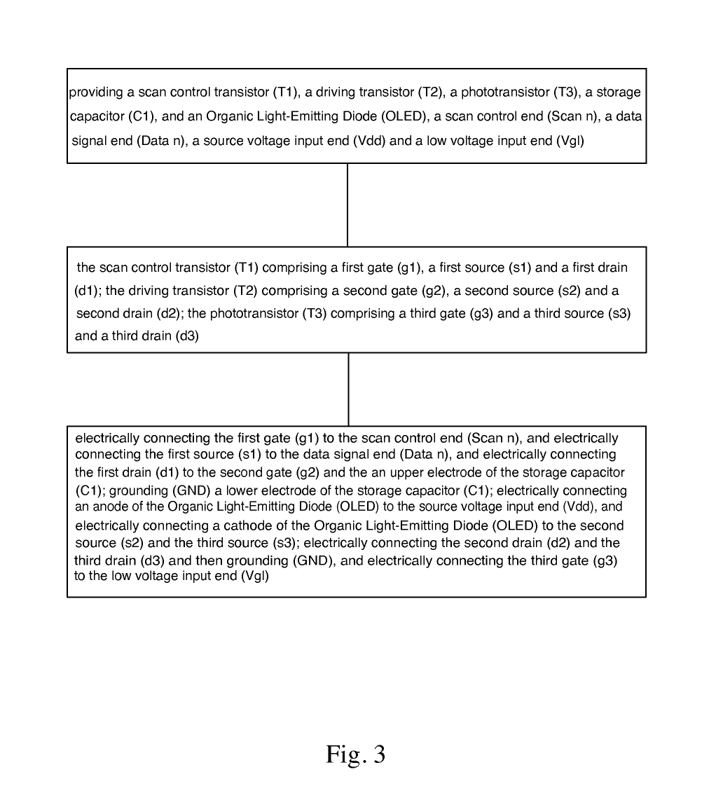

Please refer to FIG. 3. The present invention also provides a panel driving method, comprising:

providing a scan control transistor (T1), a driving transistor (T2), a phototransistor (T3), a storage capacitor (C1), and an Organic Light-Emitting Diode (OLED), a scan control end (Scan n), a data signal end (Data n), a source voltage input end (Vdd) and a low voltage input end (Vgl);

the scan control transistor (T1) comprises a first gate (g1), a first source (s1) and a first drain (d1); the driving transistor (T2) comprises a second gate (g2), a second source (s2) and a second drain (d2); the phototransistor (T3) comprises a third gate (g3) and a third source (s3) and a third drain (d3);

electrically connecting the first gate (g1) to the scan control end (Scan n), and electrically connecting the first source (s1) to the data signal end (Data n), and electrically connecting the first drain (d1) to the second gate (g2) and an upper electrode of the storage capacitor (C1); grounding (GND) a lower electrode of the storage capacitor (C1); electrically connecting an anode of the Organic Light-Emitting Diode (OLED) to the source voltage input end (Vdd), and electrically connecting a cathode of the Organic Light-Emitting Diode (OLED) to the second source (s2) and the third source (s3); electrically connecting the second drain (d2) and the third drain (d3) and then grounding (GND), and electrically connecting the third gate (g3) to the low voltage input end (Vgl).

The storage capacitor (C1) mainly stores a grey scale voltage signal outputted from the data signal end (Data n).

A driving current of the driving transistor (T2) is a grey scale current (I1), and a current of the phototransistor (T3) is an ambient light current (I2), and the grey scale current (I1) depends on the grey scale voltage stored in the storage capacitor (C1), and the ambient light current (I2) depends on ambient light dosage; a brightness of the panel depends on a sum of the grey scale current (I1) and the ambient light current (I2).

A brightness of the panel depends on a sum of the grey scale current (I1) and the ambient light current (I2).

The scan control transistor (T1), the driving transistor (T2) and the phototransistor (T3) are all thin film transistors.

The panel of the present embodiment is an Active Matrix/Organic Light Emitting Diode (AMOLED) panel.

In conclusion, the present invention provides a panel driving circuit and a panel driving method. By parallel connecting one phototransistor with two ends of the source and the drain of the driving transistor. The current of the phototransistor (T3) is controlled by the ambient light, and accordingly, the brightness of the panel depends on a sum of the grey scale current (I1) and the ambient light current (I2). Therefore, the brightness of the panel changes with the brightness variation of the ambient light. Consequently, the power consumption of driving the panel is reduced. The usage lifetime of the AMOLED is extended and the display image quality is enhanced.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A panel driving circuit, comprising: a scan control transistor, a driving transistor, a phototransistor, a storage capacitor, and an Organic Light-Emitting Diode; and further comprising a scan control end, a data signal end, a source voltage input end and a low voltage input end;
the scan control transistor comprises a first gate, a first source and a first drain; the driving transistor comprises a second gate, a second source and a second drain; the phototransistor comprises a third gate and a third source and a third drain;
the first gate is electrically connected to the scan control end, and the first source is electrically connected to the data signal end, and the first drain is electrically connected to the second gate and an upper electrode of the storage capacitor; a lower electrode of the storage capacitor is grounded; an anode of the Organic Light-Emitting Diode is electrically connected to the source voltage input end, and a cathode of the Organic Light-Emitting Diode is electrically connected to the second source and the third source; the second drain and the third drain are electrically connected and then grounded, and the third gate is electrically connected to the low voltage input end.

2. The panel driving circuit according to claim 1, wherein the storage capacitor stores a grey scale voltage signal outputted from the data signal end.

3. The panel driving circuit according to claim 2, wherein a driving current of the driving transistor is a grey scale current, and a current of the phototransistor is an ambient light current, and the grey scale current depends on the grey scale voltage stored in the storage capacitor, and the ambient light current depends on ambient light dosage.

4. The panel driving circuit according to claim 3, wherein a brightness of the panel depends on a sum of the grey scale current and the ambient light current.

5. The panel driving circuit according to claim 1, wherein the scan control transistor, the driving transistor and the phototransistor are all thin film transistors.

6. A panel driving circuit, comprising: a scan control transistor, a driving transistor, a phototransistor, a storage capacitor, and an Organic Light-Emitting Diode; and further comprising a scan control end, a data signal end, a source voltage input end and a low voltage input end;
the scan control transistor comprises a first gate, a first source and a first drain; the driving transistor comprises a second gate, a second source and a second drain; the phototransistor comprises a third gate and a third source and a third drain;
the first gate is electrically connected to the scan control end, and the first source is electrically connected to the data signal end, and first drain is electrically connected to the second gate and an upper electrode of the storage capacitor; a lower electrode of the storage capacitor is grounded; an anode of the Organic Light-Emitting Diode is electrically connected to the source voltage input end, and a cathode of the Organic Light-Emitting Diode is electrically connected to the second source and the third source; the second drain and the third drain are electrically connected and then grounded, and the third gate is electrically connected to the low voltage input end;
wherein the storage capacitor stores a grey scale voltage signal outputted from the data signal end;
wherein a driving current of the driving transistor is a grey scale current, and a current of the phototransistor is an ambient light current, and the grey scale current depends on the grey scale voltage stored in the storage capacitor, and the ambient light current depends on ambient light dosage;
wherein a brightness of the panel depends on a sum of the grey scale current and the ambient light current;
wherein the scan control transistor, the driving transistor and the phototransistor are all thin film transistors.

7. A panel driving, comprising:
providing a scan control transistor, a driving transistor, a phototransistor, a storage capacitor, an Organic Light-Emitting Diode, a scan control end, a data signal end, a source voltage input end and a low voltage input end;
the scan control transistor comprises a first gate, a first source and a first drain; the driving transistor comprises a second gate, a second source and a second drain; the phototransistor comprises a third gate and a third source and a third drain;
electrically connecting the first gate to the scan control end, and electrically connecting the first source to the data signal end, and electrically connecting first drain to the second gate and an upper electrode of the storage capacitor; grounding a lower electrode of the storage capacitor; electrically connecting an anode of the Organic Light-Emitting Diode to the source voltage input end, and electrically connecting a cathode of the Organic Light-Emitting Diode to the second source and the third source; electrically connecting the second drain and the third drain and then grounding, and electrically connecting the third gate to the low voltage input end.

8. The panel driving circuit according to claim 7, wherein the storage capacitor stores a grey scale voltage signal outputted from the data signal end.

9. The panel driving circuit according to claim 8, wherein a driving current of the driving transistor is a grey scale current, and a current of the phototransistor is an ambient light current, and the grey scale current depends on the grey scale voltage stored in the storage capacitor, and the ambient light current depends on ambient light dosage.

10. The panel driving circuit according to claim 9, wherein a brightness of the panel depends on a sum of the grey scale current and the ambient light current.

11. The panel driving circuit according to claim 7, wherein the scan control transistor, the driving transistor and the phototransistor are all thin film transistors.
